(19) United States
(12) Patent Application Publication
(10) Pub. No.: US 2011/0155663 A1
(43) Pub. Date: Jun. 30, 2011

(54) WASTEWATER TREATMENT SYSTEM

(76) Inventors: John M. McNellis, Manhattan, KS (US); Robin D. Mahan, Manhattan, KS (US); Jeri L. Meyer, St. George, KS (US); Todd L. Steinbach, Manhattan, KS (US)

(21) Appl. No.: 12/937,761

(22) PCT Filed: Apr. 18, 2008
(86) PCT No.: PCT/US08/60858

§ 371 Date: Dec. 3, 2010

(51) Int. Cl. B01D 17/025; A01N 25/34; A01N 59/20; A01P 1/00

(52) U.S. Cl. 210/523; 424/411; 424/630

(57) ABSTRACT

A wastewater treatment system for removing settled material from a supply of wastewater includes an open-top clarifier tank for holding wastewater having a minimum upper surface level, a support member supported above the clarifier tank and a wastewater treatment module positioned to be located at least partially below the clarifier tank upper surface level so as to have a submerged portion within the wastewater contained within the clarifier tank. At least part of the submerged portion, which can include an effluent supply conduit, has an outer surface formed of an anti-biologic material. The anti-biologic material inhibits the growth of algae within the wastewater and on the anti-biologic surface. The anti-biologic material can be a copper material, and can be provided on a base material such as stainless steel.

### FIELD OF THE INVENTION

The present invention relates to a wastewater treatment system.

### SUMMARY

In one embodiment, the invention provides a wastewater treatment system for removing settled material from a supply of wastewater. The wastewater treatment system includes an open-top clarifier tank for holding wastewater, the clarifier tank having a minimum wastewater upper surface level, a support member supported above the clarifier tank and a wastewater treatment module submerged below the clarifier tank upper surface level so as to have a submerged portion within the wastewater contained within the clarifier tank. An anti-biologic material is provided on an outer surface of the submerged portion. The anti-biologic material can inhibit the growth of algae within the wastewater. The anti-biologic material can include a copper material and can be provided on a base material that is non-anti-biologic.

In another embodiment, the invention provides a method of inhibiting growth of biologics in a wastewater treatment system. The method includes providing an effective amount of anti-biologic material on an outer surface of a portion of a wastewater treatment module submerged within wastewater contained within a clarifier tank. The effective amount is an amount sufficient to inhibit the growth of biologics. The anti-biologic material can be a copper material and can be provided on a base material that is non-anti-biologic.

In another embodiment, the invention provides a wastewater treatment system for removing settled material from a supply of wastewater. The wastewater treatment system includes an open-top clarifier tank for holding wastewater, the clarifier tank having a minimum wastewater upper surface level, and a wastewater treatment module submerged below the clarifier tank upper surface level so as to have a submerged portion within the wastewater contained within the clarifier tank. An effective amount of copper material is provided on an outer surface of the submerged portion. The effective amount is an amount sufficient to inhibit the growth of algae within the wastewater.

Other aspects of the invention will become apparent by consideration of the detailed description and accompanying drawings.

### BRIEF DESCRIPTION OF THE DRAWINGS

FIG. 1 is a front view of a wastewater treatment system according to an embodiment of the invention.

FIG. 2 is a top view of the wastewater treatment system of FIG. 1.

FIG. 3 is a side view of the wastewater treatment system of FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

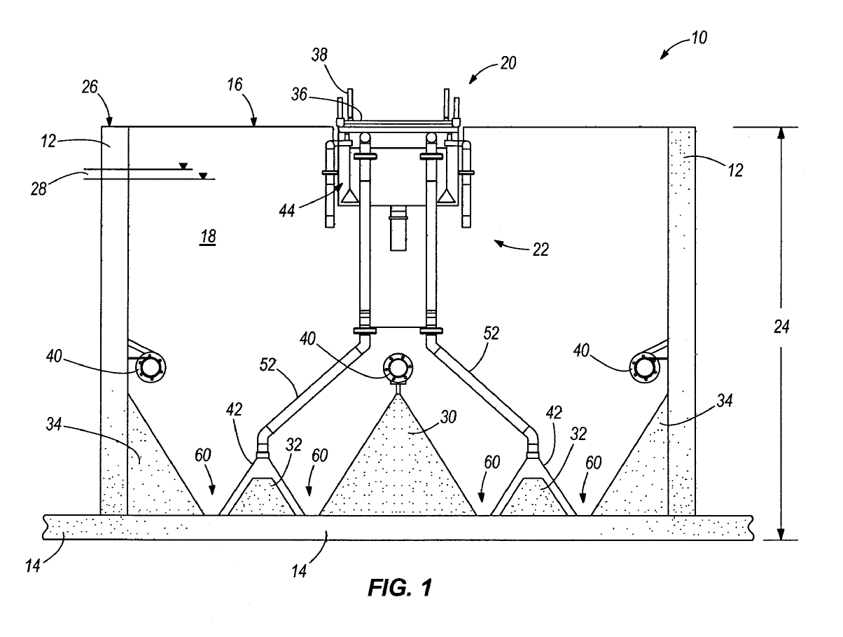

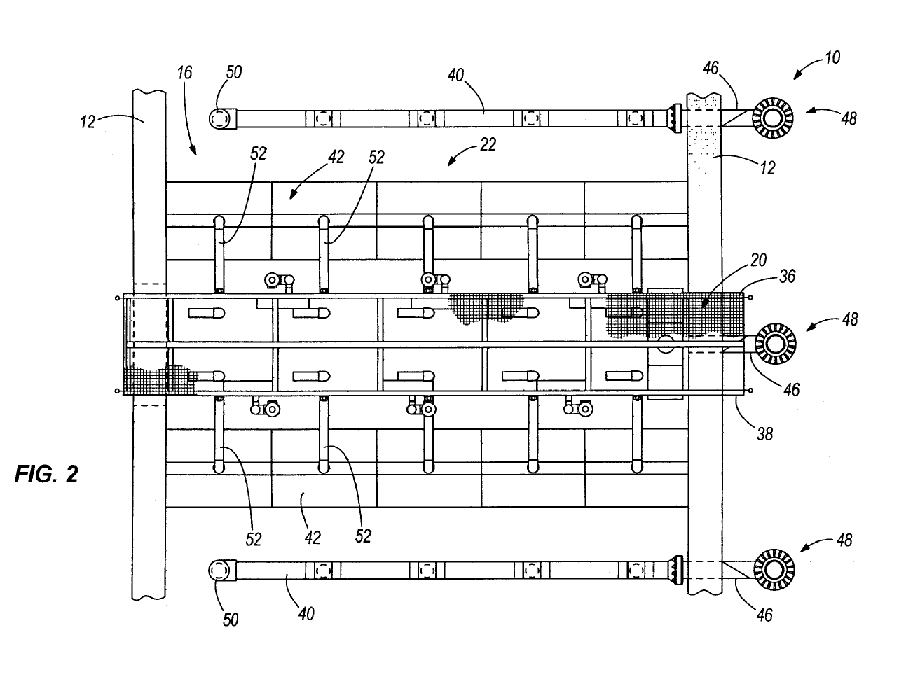

FIGS. 1-3 illustrate a wastewater treatment 10 system according to an embodiment of the invention. The wastewater treatment system 10 can be used in conjunction with municipal and industrial biological wastewater treatment plants for removing settled material, such as biomass, sediment and other solids from wastewater.

The wastewater treatment system 10 includes four sidewalls 12 and a floor 14 that define an open-top clarifier tank 16 for holding fluids, including wastewater 18. A support member 20 extends between opposing sidewalls 12 over the open top of the clarifier tank 16. A wastewater treatment module 22 is mounted to the support member 20 and extends downwardly into the clarifier tank 16. The wastewater treatment system 10 can be similar to that described in U.S. Pat. No. 5,035,795, and U.S. Pat. No. 7,284,670, the entire contents of which are hereby incorporated herein by reference.

The clarifier tank 16 sidewalls 12 can be made of concrete and can have a depth 24 (i.e., a distance from the floor 14 to a top 26 of the sidewalls 12) of from about 14 to about 20 feet. Wastewater 18 can be held within the clarifier tank 16 at a minimum surface level 28 (see FIG. 1) from about 21 inches to about 26 inches from the top 26 of the clarifier tank sidewalls 12.

The clarifier tank floor 14 can also be made of concrete. The floor 14 is formed with a plurality of longitudinally extending, laterally spaced apart peaks, including a taller center peak 30, shorter lateral peaks 32, and angled side peaks 34.

The support member 20 includes a floor grating 36 and guard rails 38. The support member 20 can be accessed by an operator to visually inspect the wastewater treatment system 10 from above and also to access the clarifier tank 16 and the wastewater treatment module 22 for installation, cleaning and servicing.

The wastewater treatment module 22 includes one or more wastewater supply conduits 40, one or more suction hoods 42 for removing settled material from the wastewater 18 within the clarifier tank 16, and one or more effluent removal assemblies 44 for removing effluent from the clarifier tank 16. All or part of the components of the wastewater treatment module 22 can be located below the minimum surface level 28 of the clarifier tank 16 so as to be submerged below the upper surface of the wastewater 18 contained within the clarifier tank 16.

The wastewater supply conduit 40 enters into the clarifier tank 16 through sidewall 12 and extends approximately parallel to and directly below the support member 20. An inlet end 46 of the wastewater supply conduit 40 communicates with an inlet screen 48 for receiving a supply of wastewater. An outlet end 50 of the wastewater supply conduit 40 has an opening for releasing wastewater into the clarifier tank 16. The outlet end 50 of the wastewater supply conduit 40 is positioned above the central peak 30 of the clarifier tank floor 14.

First and second suction hoods 42 are positioned over the lateral peaks 32 of the clarifier tank floor 14. The suction hoods 42 are in fluid communication with airlifts 52 that can be located remote to the clarifier tank 16.

Influent to the clarifier tank 16, including wastewater and solids, is drawn into the clarifier tank 16 through the inlet screen 48. Larger particles of solids are removed from the flow of influent at the inlet screen 48. The influent flows into the clarifier tank 16 though the outlet end 50 of the wastewater supply conduit 40 and is distributed evenly across the lower portion of the clarifier tank 16. As the influent resides in the clarifier tank 16, solids within the influent settle downwardly to the floor 14 of the clarifier tank 16. The angled sides of the peaks 30, 32, 34 guide the settling material into angled valleys 60 between adjacent peaks 30, 32, 34. Vacuum or suction pressure is exerted at the suction hoods 42 via the airlifts 52. The settled material is drawn upwardly into the suction hoods 42 and is removed from the clarifier tank 16 via the airlifts 52.

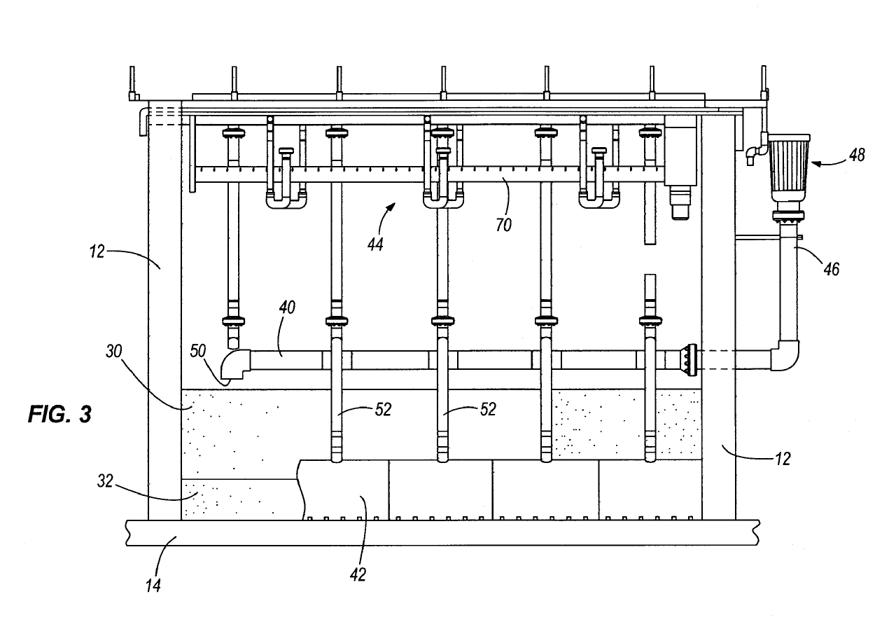

The effluent removal assembly 44 is positioned above the suction hoods 42 in an upper region of the influent within the clarifier tank 16. The effluent removal assembly 44 draws effluent (i.e., wastewater from which solids have settled out) out of the clarifier tank 16. The effluent removal assembly 44 can include one or more effluent intake conduits 70 (see FIG. 3) arranged parallel to the support member 20 and submerged below the surface of the fluid within the clarifier tank 16. The effluent intake conduits 70 have inlet ends into which effluent is drawn for removal from the clarifier tank 16.

Part or all of outer surfaces 72 of the effluent intake conduits 70 can be formed of a material adapted for inhibiting the growth of biologics, i.e., an anti-biologic material. By biologic, it is meant at least one of algae, bacteria, fungi other living organisms, micro-organisms, micro-plants and combinations thereof. The anti-biologic surfaces 72 of the effluent intake conduits 70 are submerged in the wastewater, thus inhibiting the growth of biologics in the wastewater within the clarifier tank 16. The anti-biologic material also inhibits the growth of biologics on the anti-biologic surfaces 72 themselves.

In one embodiment, the anti-biologic material comprises copper material in which sufficient copper is present to inhibit the growth of biologics. In other words, the copper material comprises an effective amount of copper to inhibit the growth of biologics. The copper material can therefore include at least one of copper, a copper alloy, a compound containing copper ions and a combinations thereof.

Copper material can be provided on the outer surfaces 72 of the effluent intake conduits 70 according to a variety of methods. The effluent intake conduits 70 can be formed entirely of copper material. However, extensive use of copper can be prohibitively costly. Alternately, copper material can be provided on an outer surface of a base material, such as stainless steel. The effluent intake conduits 70 can therefore be formed of a non-anti-biologic material, over the outer surfaces of which copper material has been provided. The base material can be a metal such as stainless steel or carbon steel, or a non-metal such as PVC.

Copper material can be directly or indirectly provided on the outer surface of the base material. In other words, additional layers may be found between the base material and the copper material. The copper material can be provided on the base material through various processes as are known in the art, including plating and fusing. Also, copper material can be retro-fit onto existing effluent removal conduits (i.e., the existing effluent removal conduit forms the base material). For example, sheets of copper material can be bent around and secured to the effluent removal conduit 70 to cap the effluent removal conduit 70 with the copper material.

Because the outer surfaces of the effluent intake conduits 70 are formed of an anti-biologic material, growth of biologics, including algae, in the effluent within the clarifier tank 16 can be reduced. This can increase the clarity of the effluent, providing a cleaner appearance of the fluid within the clarifier tank 16 and of the effluent withdrawn from the clarifier tank 16. Also, reduced algae growth can reduce the need to clean the effluent intake conduits 70 and other submerged components of the clarifier tank 16 by inhibiting algae growth on the outer surfaces 72 of the effluent intake conduits 70 and of the other components themselves. Also, the growth of organisms within the clarifier tank 16 that feed on biologics, such as algae, can be inhibited by reducing the food supply, i.e., the biologics.

Other components of the wastewater treatment system 10 that are all or partly submerged within the fluid 18 contained in the clarifier tank 16 can also have anti-biologic outer surfaces. Such components can include the wastewater supply conduit 40, and the suction hoods 42.

Thus, the invention provides, among other things, a clarifier tank in which the outer surfaces of submerged components, including effluent removal conduits, are formed of an anti-biologic material such as a copper material having an effective amount of copper to inhibit the growth of biologics within the fluid in which the components are submerged.

What is claimed is:

1. A wastewater treatment system for removing settled material from a supply of wastewater, the wastewater treatment system comprising:
an open-top clarifier tank for holding wastewater, the clarifier tank having a minimum wastewater upper surface level;
a support member supported above the clarifier tank; and
a wastewater treatment module submerged below the clarifier tank upper surface level so as to have a submerged portion within the wastewater contained within the clarifier tank; and
an anti-biologic material provided on an outer surface of the submerged portion.

2. The wastewater treatment system of claim 1, wherein the anti-biologic material inhibits the growth of algae in the wastewater contained within the clarifier tank.

3. The wastewater treatment system of claim 1, wherein the anti-biologic material inhibits the growth of algae on the anti-biologic surfaces.

4. The wastewater treatment system of claim 1, wherein the anti-biologic material comprises an effective amount of at least one of copper, a copper alloy, a compound containing copper ions and a combination thereof.

5. The wastewater treatment system of claim 1, wherein the anti-biologic material is provided on a base material that is non-anti-biologic.

6. The wastewater treatment system of claim 1, wherein the submerged portion of the wastewater treatment module includes an effluent intake conduit.

7. A method of inhibiting growth of biologics in a wastewater treatment system, the method comprising:
providing an effective amount of anti-biologic material on an outer surface of a portion of a wastewater treatment module submerged within wastewater contained within a clarifier tank, the effective amount being sufficient to inhibit the growth of biologics.

8. The method of claim 7, wherein the anti-biologic material is supported on a non-anti-biologic base material.

9. The method of claim 8, wherein the anti-biologic material is provided on the base material by a plating process.

10. The method of claim 8, wherein the anti-biologic material is provided on the base material by a fusing process.

11. The method of claim 8, wherein the anti-biologic material is provided on the base material by attaching a sheet of anti-biologic material to the base material.

12. The method of claim 7, wherein the anti-biologic material comprises an effective amount of at least one of copper, a copper alloy, a compound containing copper ions and a combination thereof.

13. A wastewater treatment system for removing settled material from a supply of wastewater, the wastewater treatment system comprising:
an open-top clarifier tank for holding wastewater, the clarifier tank having a minimum wastewater upper surface level;
a wastewater treatment module submerged below the clarifier tank upper surface level so as to have a submerged portion within the wastewater contained within the clarifier tank; and
an effective amount of copper material provided on an outer surface of the submerged portion, the effective amount being sufficient to inhibit the growth of algae within the wastewater.

14. The wastewater treatment system of claim 13, wherein the copper material inhibits the growth of algae on the copper material.

15. The wastewater treatment system of claim 13, wherein the copper material comprises an effective amount of at least one of copper, a copper alloy or a compound containing copper ions.

16. The wastewater treatment system of claim 13, wherein the copper material is provided on a base material that is non-anti-biologic.

17. The wastewater treatment system of claim 13, wherein the submerged portion of the wastewater treatment module includes an effluent intake conduit.
